(19) United States
(12) Patent Application Publication
(10) Pub. No.: US 2023/0312854 A1
(43) Pub. Date: Oct. 5, 2023

(54) PHENOLIC FOAM

(71) Applicant: KINGSPAN HOLDINGS (IRL) LIMITED, Cavan (IE)

(72) Inventors: Parmjit HEER KAUR, Wolverhampton (GB); Ruud ZEGGELAAR, Arnhem (NL); Arno VERHOEVEN, Waalwijk (NL); Vincent COPPOCK, Bunbury (GB)

(21) Appl. No.: 18/023,278

(22) PCT Filed: Aug. 30, 2021
(86) PCT No.: PCT/EP2021/073909

§ 371 Date: Feb. 24, 2023

(30) Foreign Application Priority Data
Aug. 31, 2020 (GB) 2013654.5

(51) Int. Cl. C08J 9/00; C08J 9/14; C08G 77/46; C08L 61/06; C08L 91/00

(52) U.S. Cl. CPC C08J 9/0042; C08J 9/0061; C08J 9/141; C08J 9/144; C08G 77/46; C08L 61/06; C08L 91/00; C08G 2101/00

(57) ABSTRACT

A phenolic foam formed from a composition comprising a phenolic resin, a blowing agent, an acid catalyst, and a surfactant comprising: (i) an ethoxylated castor oil, and (ii) a polysiloxane comprising a side chain comprising polyethylene oxide wherein the total molecular weight of the polyethylene oxide of the side chain comprises less than 50% of the total molecular weight of the polysiloxane.

### FIELD OF THE INVENTION

The invention relates to a phenolic foam, a composition for forming a phenolic foam, and the use of a phenolic foam.

### BACKGROUND TO THE INVENTION

Phenolic foam is used in thermal insulation applications such as in construction materials. Generally phenolic foams have superior thermal insulation and superior fire resistance characteristics as compared to other foams such as polyisocyanurate (PIR) and polyurethane (PU) foams.

Phenolic foam is produced by expanding and curing a foamable composition prepared by mixing a phenolic resin, a surfactant, a blowing agent, and an acid catalyst. Other additives can be optionally mixed into the resin such as plasticisers, flame retardants, or pigments.

Blowing agents having low thermal conductivity are used to form thermal insulating foams. As the gas volume of a foam may account for up to about 95% of the volume of a foam, the amount and nature of the blowing agent trapped in the foam has a significant impact on the thermal insulating performance of the foam. In order to form thermal insulating foam, a total closed cell content of 85 percent or more is generally required, as one of the main determinants in the thermal insulation performance of foam is the ability of the cells of the foam to retain blowing agent having a low thermal conductivity.

The thermal insulation properties of phenolic foam are dependent on the retention of blowing agent having a low thermal conductivity, in a closed cell structure formed during the formation of the phenolic foam. Important properties of phenolic foam are: cell size, which is desirably in a micrometre range, and cells which are uniformly distributed, providing a closed cell structure to enhance the thermal insulation properties of phenolic foam products by retention of blowing agents.

It is desirable that insulation products do not see a degradation in insulation performance over time. As outlined above, the thermal conductivity of a thermal insulation foam is significantly influenced by the blowing agent used to form the foam, and the retention of the blowing agent in the foam. Typically blowing agents are chosen which have superior thermal insulation than air. Foam may lose blowing agent from closed cells over time, and as blowing agent is lost from the cells of the foam and air diffuses into said cells in place of the blowing agent, the thermal conductivity increases. This results in the initial thermal conductivity (lambda value measured using EN 13166:2012) of the foam increasing over time, representing a decrease in the thermal insulation performance of the product over time (aged lambda value measured using EN 13166:2012).

Phenolic foams may also see a degradation in insulation performance over time due to the absorption of water and moisture from the environment. Phenolic foam may absorb water over time, which will result in an increase in the thermal conductivity to the foam.

Phenolic foams are used in a great variety of applications, due to their combination of thermal insulation and fire performance. The thermal insulation performance of the product may be the main reason for selection of this insulation material. Examples of such applications are cavity wall applications and concrete wall and floor sandwich constructions. Suitable thermal insulation foams would satisfy the requirements of 13166:2012+A2 2016 specification

In a cavity wall construction, the insulation boards are installed against the inner wall. In the majority of cases, the insulation boards are fixed by drilling wall ties into the insulation material. In the second stage, the external wall is installed. In a traditional cavity wall, a small air gap between the insulation board and outer wall is maintained to prevent moisture flow from the outer wall into the insulation material. When there are air gaps, for example over 15 mm, a reflective foil facer may be used to increase thermal insulation performance this improved performance is because of emissivity of such a facer.

For concrete wall and floor sandwich constructions, these are generally pre-cast in a factory and installed on the building site. In this application, insulation boards are installed on a lower concrete layer. The wet concrete mixture is poured over the foam insulation board and cured before dispatch to the building site. In floor applications, the insulation boards are applied under a layer of concrete with or without a floor heating system.

Applications can make it very difficult or even impossible to replace the insulation during the service life of the building. For this reason, stable thermal insulation performance over the full life span of the building is critical. To maintain this required thermal insulation performance, the diffusion of the blowing agent out of the insulation boards should be minimal.

Phenolic resole resins which are used in the manufacture of phenolic foams are condensation polymers of phenol and formaldehyde made under aqueous basic conditions with an excess of formaldehyde. In general, phenolic resins used in phenolic foam manufacture are viscous liquids with water concentrations of from about 1 to 25 wt % and have methylol groups as reactive substituents. Cross-linked phenolic foam may be formed by heating and curing a mixture of phenolic resin, blowing agent, surfactant and acid catalyst. Upon addition of an acid catalyst to a mixture comprising resin, blowing agent and surfactant, an exothermic reaction occurs between methylol groups and phenolic rings to form methylene bridges, which cross-link polymeric chains, and water of condensation polymerisation is produced. The resole resin composition, the quantity and nature of the acid curing catalyst and the chemical and physical properties of the blowing agent and any surfactant present in the foam reactants greatly influence the ability to control the exothermic reaction and the ability to form closed cell foam.

The amount of water in the reactants that form the foam and in particular the amount of water in the resin may influence the amount of acid catalyst required to complete the reaction. For example with higher water content in the reactants, a greater concentration of acid may be required. Acid catalysed condensation polymerisation reactions lead to release of water into the phenolic resin foamable composition.

Water behaves as an exothermic sink slowing down the cross-linking reactions needed to make a rigid phenolic foam board. Acid catalyst systems used in production are hygroscopic, which in turn increase the water content of the phenolic foam board compromising thermal insulation properties. As the acid catalysts used in the production of foam are typically hygroscopic, higher amounts of residual acid in a foam product can increase the rate of absorption of water in the foam, and cause a concomitant increase in thermal conductivity.

Accordingly, minimising the amount of acid required is desirable. Furthermore, residual acid may lead to undesirable properties in the foam. For example phenolic foams may have a low pH in the range of from about 2 to 3. The acidic nature of phenolic foam can in turn lead to issues with corrosion of metals which are in contact with the phenolic foam, for example when the phenolic foam is in contact with a metal part of a building structure. For this reason care is taken in production of phenolic foams for use in insulation applications to minimise and/or neutralise any residual acid.

Notwithstanding the foregoing, the reaction to form a phenolic foam is an acid-catalysed reaction, thus some acid is required to cross-link the resin, and cure the foam. The heat released during the exothermic acid-catalysed reaction causes expansion of the blowing agent in the resin. Thus a balance needs to be struck between having sufficient acid catalyst to catalyse the reaction and cure the foam, without forming a foam with a high residual acid and water content, which will over time have poor thermal insulation.

Surfactants are generally used in phenolic resin foamable compositions to facilitate the formation of cells which are structurally more stable, which in turn reduces loss of blowing agent from the resulting foam over time. Surfactants may also aid in the emulsification of blowing agent within phenolic foam resin. This in turn can lead to the production of a foam which is more stable against blowing agent loss and indeed with better blowing agent retention. Surfactants may also influence the brittleness of phenolic foams, partly due to residual water in the foam. This is particularly the case for lower density phenolic foams below around 32 kg/m3 density.

Many solutions to the problem of providing a phenolic foam with a stable low thermal conductivity over time have been provided. For example, Patent No. EP1922357 describes a phenolic foam which is made by foaming and curing a foamable phenolic resin composition that comprises a phenolic resin, a blowing agent, an acid catalyst and an inorganic filler. The blowing agent comprises an aliphatic hydrocarbon containing from 1 to 8 carbon atoms and the inorganic filler is at least one selected from a metal hydroxide, a metal oxide, a metal carbonate and a metal powder. The phenolic foam has a pH of 5 or more. The phenolic foam has a higher pH value compared with conventional phenolic foam and reduces corrosion risk when in contact with metallic materials. The phenolic foam maintains excellent long-term stable thermal insulation performance, low water uptake and fire resistance performance and by using a hydrocarbon blowing agent, does not harm the environment as an ozone depleting or global warming material.

Notwithstanding the state of the art, it would be desirable to provide a phenolic foam having excellent insulation properties over time, and having minimal residual acid. These and other desires are solved by the present invention.

### SUMMARY OF THE INVENTION

According to the invention there is provided a phenolic foam formed from a composition comprising:

a phenolic resin,

a blowing agent,

an acid catalyst, and

a surfactant comprising an ethoxylated castor oil, and a polysiloxane comprising a side chain, the side chain comprising polyethylene oxide wherein the total molecular weight of the polyethylene oxide of the side chain comprises less than 50% of the total molecular weight of the polysiloxane.

Advantageously, the phenolic foam of the present invention may have a closed cell content of greater than 90%. The phenolic foam may have an aged thermal conductivity after aging for 14 days at 110° C. of less than 0.022 W/m·K, for example less than 0.020 W/m·K, for example less than 18 W/m·K, as measured by EN 13166:2012 (Method 2 Annex C). It is beneficial to provide a foam product which exhibits such a low aged thermal conductivity value.

Surfactants affect foam structure and are used to provide stability to the cells of the foam. Surfactants act as surface active agents by lowering the surface tension of the liquid phase of the phenolic resin and by providing an interface between the highly polar phenolic resin and the relatively less polar blowing agent. The formation of closed cells is driven by the internal pressure of the expansion of the blowing agent and is counteracted by the surface tension of the liquid phase of the phenolic resin. A surfactant which decreases the surface tension excessively will lead to rupture of the cells during foam expansion leading to poor insulation properties due to less blowing agent being retained in the phenolic foam or the foam may collapse. A surfactant which decreases the surface tension insufficiently will lead to poor expansion of the foam, large and uneven cell structure and poor insulation properties due to less blowing agent being retained in the phenolic foam, or the foam may collapse.

Surprisingly it has been discovered that a surfactant which comprises:
(i) a polysiloxane comprising a side chain comprising polyethylene oxide wherein the total molecular weight of the polyethylene oxide of the side chain comprises less than 50% of the total molecular weight of the polysiloxane, and
(ii) an ethoxylated castor oil,
   provides an ideal surface tension between a polar phenolic resin and a relatively less polar blowing agent for forming a phenolic foam with an aged thermal conductivity after aging for 14 days at 110° C. of less than 0.022 W/m·K, for example less than 0.020 W/m·K, for example less than 18 W/m·K, as measured by EN 13166:2012 (Method 2 Annex C). The phenolic foam may have a closed cell content of greater than about 90%. The presence of the surfactant in the final foam can be determined by any suitable analytic technique. The presence of the surfactant in the final foam can be determined by spectroscopy/spectrometry, for example, mass spectrometry such as gas chromatography mass spectroscopy (GC-MS) or pyrolysis gas chromatography mass spectrometry [Pyr-GCMS], nuclear magnetic resonance spectroscopy (NMR), raman spectroscopy, inductively coupled plasma optical emission spectroscopy [ICP-OES] and/or Fourier-transform infrared spectroscopy (FT-IR).

As outlined above, the phenolic foam of the invention is formed from a composition wherein the surfactant comprises a polysiloxane wherein the polysiloxane has a molecular weight of from about 9,500 to about 25,000 g/mol. Beneficially the phenolic foam comprising a surfactant wherein the polysiloxane has a molecular weight of from about 9,500 to about 25,000 g/mol achieves an aged thermal conductivity after aging for 14 days at 110° C. of less than 0.022 W/m·K, for example less than 0.020 W/m·K, for example less than 0.018 W/m·K, as measured by EN 13166:2012 (Method 2 Annex C). A phenolic foam formed from a composition comprising a surfactant wherein the molecular weight of the polysiloxane is below 9,500 g/mol leads to a composition which does not form a phenolic foam with an aged thermal conductivity after aging for 14 days at 110° C. of less than 0.022 W/m·K as measured by EN 13166:2012 (Method 2 Annex C).

The polysiloxane may comprise a dialkyl siloxane backbone, such as a dimethylsiloxane backbone. Beneficially a dialkyl siloxane backbone, such as a dimethylsiloxane backbone is lipophilic and allows the surfactant to interact with the relatively less polar blowing agent.

The polysiloxane may comprise a polyoxyalkylene side chain. Beneficially the polyoxyalkylene is hydrophilic and allows the surfactant to interact with the polar phenolic resin.

The polysiloxane may comprise a polyoxyalkylene side chain, for example the polysiloxane may comprise an ethylene oxide-propylene oxide copolymer side chain. Beneficially an ethylene oxide-propylene oxide copolymer side chain allows the surfactant to be soluble in the polar phenolic resin.

The polysiloxane may comprise a polyoxyalkylene side chain wherein the ethylene oxide-propylene oxide copolymer side chain may comprise 4 or more ethylene oxide units, for example 6 ethylene oxide units, for example 8 ethylene oxide units, for example 10 ethylene oxide units, for example 12 ethylene oxide units, for example 14 ethylene oxide units, for example 16 ethylene oxide units, for example 18 ethylene oxide units, for example 20 ethylene oxide units, for example more than 20 units of ethylene oxide.

The polysiloxane may comprise a polyoxyalkylene side chain wherein the ethylene oxide-propylene oxide copolymer side chain may comprise 4 or more propylene oxide units, for example 6 propylene oxide units, for example 8 propylene oxide units, for example 9 propylene oxide units, for example 10 propylene oxide units, for example 12 propylene oxide units, for example 14 propylene oxide units, for example 16 propylene oxide units, for example 18 propylene oxide units, for example 20 propylene oxide units, for example more than 20 units of propylene oxide.

The polysiloxane may comprise a polyoxyalkylene side chain wherein the ethylene oxide-propylene oxide copolymer side chain may comprise any combination of 4 or more ethylene oxide units and 4 or more propylene oxide units, for example 18 ethylene oxide units and 6 propylene oxide units, for example 6 ethylene oxide units and 18 propylene oxide units, for example 10 units of ethylene oxide units and 9 propylene oxide units, for example 20 ethylene oxide units and 20 propylene oxide units.

The polysiloxane may be constructed from a block copolymer of a dimethylsiloxane and a polyoxyalkylene. The dimethylsiloxane allows the surfactant to interact with the relatively less polar blowing agent. The polyoxyalkylene moieties allow the surfactant to interact with the polar phenolic resin.

The polysiloxane may have a hydrophobic to lipophilic balance (HLB) of from about 7 to about 11. Beneficially the polysiloxane with a HLB of from about 7 to about 11 allows the surfactant to interact with the polar phenolic resin.

The phenolic foam is formed from a composition wherein the surfactant of the composition of the invention comprises an ethoxylated castor oil, for example a polyethoxylated castor oil.

The ethoxylated castor oil may have a HLB of from about 12 to about 14.

The phenolic foam of the invention may be formed from a composition wherein the surfactant of the composition of the invention may comprise from about 10% to about 30% polysiloxane by weight based on the total weight of the surfactant, for example about 15% to about 25%, for example about 18% to 22% polysiloxane by weight based on the total weight of the surfactant.

The surfactant of the composition for forming a phenolic foam of the invention may comprise from about 70% to about 90% ethoxylated castor oil by weight based on the total weight of the surfactant, for example from about 75% to about 85%, for example from about 78% to about 82% ethoxylated castor oil by weight based on the total weight of the surfactant.

Suitably, the composition of the invention comprises surfactant in an amount of from about 0.5 to about 10 parts per 100 parts by weight of the phenolic resin, suitably, the surfactant is present in an amount of from about 1 to about 8 parts by weight per 100 parts by weight of the phenolic resin, for example 2 to 6 parts by weight of the phenolic resin.

The composition from which the phenolic foam of the invention is formed comprises a phenolic resin.

The phenolic resin may have a molar ratio of phenol groups to aldehyde groups in the range of from about 1:1 to about 1:3.

The phenolic resin of the composition of the invention may have a water content of from about 4 wt % to about 9 wt % based on the total weight of the phenolic resin, prior to curing the foam formed by the composition. Water in phenolic resin acts as a heat sink during foam manufacture; beneficially reduced water content allows the foaming process to be accomplished with less acid catalyst. Additionally residual water is removed in an oven drying step as part of phenolic foam manufacture; accordingly, employing a phenolic resin wherein the water content is from about 4% to about 9% reduces the drying time and associated manufacturing cost in comparison to foam manufactured using phenolic resin having a higher water content.

The phenolic resin may have a viscosity of from about 17,000 cPs to about 24,000 cPs at 25° C. The viscosity of a resin employed in the manufacture of a foam of the present invention may be determined by methods known to the person skilled in the art, for example using a Brookfield viscometer (model DV-II+Pro) with a controlled temperature water bath, maintaining the sample temperature at 25° C., with spindle number S29 rotating at 20 rpm or appropriate rotation speed and spindle type or suitable test temperature to maintain an acceptable mid-range torque for viscosity reading accuracy.

The phenolic resin may have a viscosity of about 2,600 cPs to about 4,000 cPs at 40° C. The viscosity of a resin employed in the manufacture of a foam of the present invention may be determined by methods known to the person skilled in the art for example using a Brookfield viscometer (model DV-II+Pro) with a controlled temperature water bath, maintaining the sample temperature at 40° C., with spindle number S29 rotating at 130 rpm or appropriate rotation speed and spindle type or suitable test temperature to maintain an acceptable mid-range torque for viscosity reading accuracy.

The phenolic resin may have a low free formaldehyde content of from about 0.1% to about 0.5% as a wt % of the phenolic resin, preferably from about 0.1% to about 0.3% as a wt % of the total resin when measured by potentiometric titration according to ISO 11402:2004 using hydroxylamine hydrochloride procedure. A free formaldehyde content of from about 0.1% to about 0.5% as a wt % of the total resin is desirable.

The composition from which the phenolic foam of the invention is formed comprises a blowing agent. The blowing agent may comprise a C₁-C₇ hydrocarbon, a C₂-C₅ halogenated hydrocarbon, a halogenated hydroolefin or combinations thereof.

The blowing agent may comprise a C₁-C₇ hydrocarbon. C₁-C₇ hydrocarbons are advantageous as blowing agents as they have low thermal conductivity, may be used to form closed cell foams having stable excellent thermal insulation performance, and have low environmental impact.

The blowing agent may comprise a C₁-C₇ hydrocarbon, the C₁-C₇ hydrocarbon comprising at least one of butane, pentane, hexane, heptane, and isomers thereof. Desirably, the butane is isobutane or cyclobutane or a combination thereof. Desirably the pentane is isopentane or cyclopentane or a combination thereof.

The blowing agent may comprise a C₂-C₅ halogenated hydrocarbon, for example, the blowing agent may comprise a chlorinated aliphatic hydrocarbon, for example the blowing agent may comprise a chlorinated aliphatic unsaturated hydrocarbon. Suitably, the chlorinated aliphatic hydrocarbon having from 2 to 5 carbon atoms will have from 1 to 4 chlorine atoms. Suitably, the chlorinated aliphatic hydrocarbon containing 2 to 5 carbon atoms is selected from the group consisting of dichloroethane, 1,2-dichloroethylene, n-propyl chloride, isopropyl chloride, butyl chloride, isobutyl chloride, pentyl chloride, isopentyl chloride, 1,1-dichloroethylene, trichloroethylene, and chloroethylene.

The blowing agent may comprise a combination of C₁-C₇ hydrocarbon and a C₂-C₅ halogenated hydrocarbon.

The blowing agent may comprise a halogenated hydroolefin. For example, the blowing agent may comprise a halogenated hydroolefin selected from the group consisting of hydrofluoroolefins and hydrochlorofluoroolefins. Halogenated hydroolefins are advantageous as blowing agents as they have low global warming potential as well as providing excellent thermal insulation properties.

The blowing agent may comprise a combination of C₁-C₇ hydrocarbons and halogenated hydroolefins.

The blowing agent may comprise a halogenated hydroolefin which is selected from the group consisting of 1-chloro-3,3,3-trifluoropropene, 1-chloro-2,3,3,3-tetrafluoro-1-propene, 1,3,3,3-tetrafluoro-1-propene, 2,3,3,3-tetrafluoro-1-propene, 1,1,1,4,4,4-hexafluoro-2-butene, 1,1,1,3,3-pentafluoro-2-propene and combinations thereof.

The blowing agent may comprise 1-chloro-3,3,3-trifluoropropene, suitably trans-1-chloro-3,3,3-trifluoropropene or cis-1-chloro-3,3,3-trifluoropropene or combinations thereof, preferably, trans-1-chloro-3,3,3-trifluoropropene.

The blowing agent may comprise trans-1,1,1,4,4,4-hexafluoro-2-butene, cis-1,1,1,4,4,4-hexafluoro-2-butene, cis-1-chloro-3,3,3-trifluoro-1-propene, cis-1-chloro-2,3,3,3-tetrafluoro-1-propene, 2,3,3,3,3-tetrafluoro-1-propene, 1,3,3,3-tetrafluoro-2-propene, 1,1,1,3,3-pentafluoro-1-propene, trans-1,2-dichoroethylene, or methyl formate or combinations thereof.

The blowing agent may comprise a C₁-C₇ hydrocarbon selected from at least one of butane, pentane, hexane, heptane, and isomers thereof.

The blowing agent may comprise a hydrocarbon and additionally a halogenated hydroolefin.

The blowing agent of the composition from which the foam of the invention is formed may comprise 20% to 80% C₁-C₇ hydrocarbon based on the total weight of the blowing agent of the composition.

The blowing agent of the composition from which the foam of the invention is formed may comprise 20% to 80% halogenated hydroolefin based on the total weight of the blowing agent of the composition.

The blowing agent may comprise from about 20 wt % to about 80 wt % 1-chloro-3,3,3-trifluoropropene and from about 20 wt % to about 80 wt % C₁-C₇ hydrocarbon, for example from about 30 wt % to about 50 wt % 1-chloro-3,3,3-trifluoropropene and from about 50 wt % to about 70 wt % C₁-C₇ hydrocarbon based on the total weight of the blowing agent.

Suitably, in the composition from which the phenolic foam of the invention is formed, the blowing agent is present in an amount of from 1 to 20 parts by weight per 100 parts by weight of the phenolic resin. Preferably, in the composition of the invention, the blowing agent is present in an amount of from 5 to 15 parts by weight per 100 parts by weight of the phenolic resin.

The composition from which the phenolic foam of the invention is formed comprises an acid catalyst wherein the acid catalyst may be an organic acid or an inorganic acid or a combination thereof.

The acid catalyst may comprise an inorganic acid such as sulfuric acid, or phosphoric acid, or an organic acid such as benzene sulfonic acid, xylene sulfonic acid, para-toluene sulfonic acid, naphthol sulfonic acid, phenol sulfonic acid, or similar, or a combination thereof.

The acid catalyst may be present from about 1 to about 20 parts by weight of the acid catalyst per 100 parts by weight of phenolic resin, suitably 5 to 15 parts by weight of the acid catalyst per 100 parts by weight of phenolic resin. It is desirable to reduce the acid catalyst present in the uncured chemical composition to reduce the amount of acid catalyst present in the phenolic foam and raise foam pH.

The phenolic foam of the invention is formed by foaming and curing the composition from which the phenolic foam of the invention is formed.

The phenolic foam formed of the present invention may have a pH of from about 3 to about 5 as measured by EN 13468:2001(e). A phenolic foam with a pH in the range from about 3 to about 5 is beneficial as corrosion of metal surfaces in contact with the phenolic foam is unlikely. Foams having lower pH than 3 may cause corrosion of metal surfaces.

The phenolic foam of the present invention may have a density of from about 10 kg/m³ to about 100 kg/m³, preferably of from about 15 kg/m³ to about 60 kg/m³, suitably from about 20 kg/m³ to about 35 kg/m³ as measured according to ASTM D1622-14. A density in the range from about 10 kg/m³ to about 100 kg/m³ is beneficial as lower density foams contain a greater amount of blowing agent per m³. This is desirable as the blowing agent greatly influences the thermal insulation performance of the foam product.

The phenolic foam of the invention may have a compressive strength of from about 110 kPa to about 220 kPa as measured by BS EN 826:2013. A compressive strength of from about 110 kPa to about 220 kPa is desirable as stronger phenolic foams are resistant to compressive damage when used as building insulation.

The phenolic foam of the present invention may have a friability of from about 10% to about 50%, preferably from about 20% to about 40% as measured by ASTM C421-88. Lower friability is desirable as the phenolic foam has less tendency to have surface dust and break under stress.

The phenolic foam formed from a composition of the invention may have an aged thermal conductivity of 0.022 W/m·K or less, such as 0.021 W/m·K or less when measured after accelerated aging at 110° C. for 14 days as per EN 12667.

The phenolic foam formed from a composition of the invention may have a closed cell content of greater than about 90%, preferably greater than about 95% as measured by ASTM D2856. It is beneficial to provide a foam with a closed cell content of greater than 90% to provide retention of the blowing agent which allows for low aged thermal conductivity.

In another aspect the invention discloses a phenolic foam composition comprising a phenolic resin,
a) a phenolic resin,
b) a blowing agent,
c) an acid catalyst, and
d) a surfactant comprising:
   a. an ethoxylated castor oil, and
   b. a polysiloxane comprising a side chain comprising polyethylene oxide wherein the total molecular weight of the polyethylene oxide of the side chain comprises less than 50% of the total molecular weight of the polysiloxane,

In another aspect the invention relates to a thermal insulation comprising the foam of the invention, for example a building thermal insulation.

In another aspect the invention relation to the use of a phenolic foam of the invention thermal insulation, for example to thermally insulate buildings.

In another aspect the invention relates to a method of manufacturing a phenolic foam comprising mixing a phenolic resin, a blowing agent, and a surfactant wherein the surfactant comprises an ethoxylated castor oil, and a polysiloxane comprising a side chain comprising polyethylene oxide wherein the total molecular weight of the polyethylene oxide of the side chain comprises less than 50% of the total molecular weight of the polysiloxane, and adding an acid catalyst to catalyse a foaming reaction and produce a foam.

In another aspect the invention relates to a surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane.

In another aspect the invention relates to a use of a surfactant package in a phenolic foam, the surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane.

In another aspect the invention relates to a use of a surfactant package in the manufacture of a phenolic foam, the surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane.

In another aspect the invention relates to a use of a surfactant package in a thermal insulation product, the surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane.

In another aspect the invention relates to a use of a surfactant package in the manufacture of a thermal insulation product, the surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane.

In another aspect the invention relates to the use of a surfactant package comprising an ethoxylated castor oil, and a polysiloxane comprising a side chain comprising polyethylene oxide wherein the total molecular weight of the polyethylene oxide of the side chain comprises less than 50% of the total molecular weight of the polysiloxane in any polymer foam, for example polyurethane and polyisocyanurate foams.

### BRIEF DESCRIPTION OF FIGURES

FIG. 1a and FIG. 1b show the cell structure of a foam formed from a composition in which the surfactant comprises only a polysiloxane surfactant, no ethoxylated castor oil is present in the composition (comparative example 1). The cell structure is shown at 200× magnification. The cell structure is poor. The cell structure has a wide distribution of cell sizes and shows the presence of coalescence where cells have merged together to form large cells.

FIG. 2a and FIG. 2b show the cell structure of a foam formed from a composition in which the surfactant comprises an ethoxylated castor oil component and a polysiloxane component comprising a side chain comprising polyethylene oxide wherein the total molecular weight of the polyethylene oxide of the side chain comprises 51% of the total molecular weight of the polysiloxane (comparative example 3). The cell structure is shown at 200× magnification. The cell structure is poor. The cell structure has a wide distribution of cell sizes and shows the presence of coalescence where cells have merged together to form large cells.

### DETAILED DESCRIPTION OF THE INVENTION

The invention will be more clearly understood from the following description thereof given by way of example only.

The composition for forming a phenolic foam comprises a phenolic resin, a surfactant, an acid catalyst, and a blowing agent.

A preferred type of phenolic resin which may be employed in the composition is a resole resin. Such resole resin can be obtained from the chemical reaction of phenol or a phenol-based compound such as cresol, xylenol, para-alkylphenol, para-phenylphenol, resorcinol, and the like with an aldehyde such as formaldehyde, furfural, acetaldehyde and the like using a catalytic amount of alkali such as sodium hydroxide, potassium hydroxide, calcium hydroxide, or an aliphatic amine such as trimethylamine, or triethylamine. These types of chemical constituent are commonly used in standard resole resin production, but the invention is not limited to phenolic foams manufactured from phenol resins formed from only those chemicals listed here.

The molar ratio of phenol groups to aldehyde groups is desirably in the range from 1:1 to 1:3. As the molar ratio of phenol to aldehyde groups decreases foams may have increased residual formaldehyde and this is undesirable.

The water content of the phenolic resin may be from about 4 wt % to about 9 wt %, based on the total weight of the phenolic resin, and as determined by Karl Fisher analysis. The phenolic resin having a low water content from about 4 wt % to about 9 wt % reduces the amount of acid catalyst needed to cure the foam.

The phenolic resin may have a viscosity of from about 17,000 cPs to about 24,000 cPs or less at 25° C.

The phenolic resin may have a viscosity of from about 2,600 cPs to about 4,000 cPs or less at 40° C.

The phenolic resin preferably has a free formaldehyde content of below about 0.5 wt % based on the total weight of the phenolic resin, suitably below about 0.4 wt %, suitably below about 0.3 wt %, suitably below about 0.2 wt % based on the total weight of the phenolic resin when measured by titration following ISO 11402:2004.

The composition of the present invention comprises a surfactant. The surfactant comprises (i) an ethoxylated castor oil, and (ii) a polysiloxane comprising a side chain comprising polyethylene oxide wherein the total molecular weight of the polyethylene oxide of the side chain comprises less than 50% of the total molecular weight of the polysiloxane.

The surfactant of the present invention comprises a polysiloxane which may have the general chemical structure:

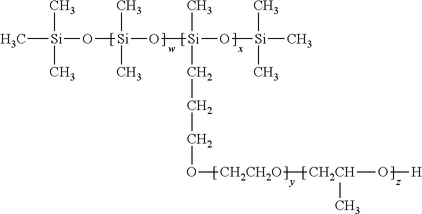

wherein
w is from 1 to 100,
x is from 1 to 50,
y is from 1 to 100,
z is from 1 to 50.
   The number of repeat units is not particularly limited as long as the polysiloxane comprises a side chain comprising polyethylene oxide wherein the total molecular weight of the polyethylene oxide of the side chain comprises less than 50% of the total molecular weight of the polysiloxane.

Desirably the polysiloxane contains Si—C bonds which are not prone to hydrolysis during acid catalysis of the condensation polymerisation reaction that occurs in phenolic foam manufacture, for example the —Si—(CH2)3—O— functionality in the hydroxy-terminated polyoxyalkylene polymethyl siloxane may offer resistance to hydrolysis during acid catalysis of the condensation polymerisation reaction that occurs in phenolic foam manufacture.

The polysiloxane may have a HLB from about 7 to about 11.

The polysiloxane may have a molecular weight of from about 9,500 to about 25,000 g/mol.

The polysiloxane may comprise a polyoxyalkylene side chain which may be an ethylene oxide-propylene oxide copolymer side chain. The ethylene oxide-propylene oxide copolymer side chain may have 4 or more ethylene oxide units, for example 6 ethylene oxide units, for example 8 ethylene oxide units, for example 10 ethylene oxide units, for example 12 ethylene oxide units, for example 14 ethylene oxide units, for example 16 ethylene oxide units, for example 18 ethylene oxide units, for example 20 ethylene oxide units, for example more than 20 units of ethylene oxide. The ethylene oxide-propylene oxide copolymer side chain may have 4 or more propylene oxide units, for example 6 propylene oxide units, for example 8 propylene oxide units, for example 9 propylene oxide units, for example 10 propylene oxide units, for example 12 propylene oxide units, for example 14 propylene oxide units, for example 16 propylene oxide units, for example 18 propylene oxide units, for example 20 propylene oxide units, for example more than 20 units of propylene oxide. The polysiloxane may comprise a polysiloxyalkylene side chain wherein the ethylene oxide-propylene oxide copolymer side chain may comprise any combination of 4 or more ethylene oxide units and 4 or more propylene oxide units, for example 18 ethylene oxide units and 6 propylene oxide units, for example 6 ethylene oxide units and 18 propylene oxide units, for example 10 units of ethylene oxide units and 9 propylene oxide units, for example 20 ethylene oxide units and 20 propylene oxide units.

The surfactant which is used in the composition which forms the phenolic foam of the present invention comprises an ethoxylated castor oil. Castor oil is a non-drying oil derived from castor oil beans that contain relatively large amount of unsaturated acids such as ricinoleic acid, oleic acid, and linoleic acid and a small amount of saturated acids such as stearic acid and dioxystearic acid. The castor oil is ethoxylated. The castor oil may be polyethoxylated. The castor oil may have from about 10 to 50 ethylene oxide units, for examples 20 to 40 ethylene oxide units. The ethoxylated castor oil may have a HLB value of from about 12 to about 14.

In the present invention the polysiloxane component and the ethoxylated castor oil component are blended to form a surfactant which has a HLB value from about 9 to about 13.

The blowing agent may comprise any suitable blowing agent. In choosing the blowing agent, it must be remembered that the thermal conductivity of the phenolic foam is directly related to the thermal conductivity of the blowing agent entrapped in the foam i.e. the blowing agent trapped in the closed cells of the foam. Preferably, the blowing agent employed in the manufacture of the foam insulation cores of the present invention has low thermal conductivity and low environmental impact. Preferably, the blowing agents have low global warming potential and low ozone depletion potential. Preferably, the blowing agents have good fire retardancy properties. Suitably the blowing agent comprises a C₁ to C₇ hydrocarbon, a C₂ to C₅ halogenated hydrocarbon, a halogenated hydroolefin or combinations thereof.

Suitably the blowing agent comprises a C₁ to C₇ hydrocarbon which may be at least one of butane, pentane, hexane, heptane, or combinations thereof. Suitably the blowing agent comprises a C₁ to C₇ hydrocarbon which may be at least one of butane, pentane, hexane, heptane, or isomers thereof, or combinations thereof. Suitably the blowing agent comprises a C₁ to C₇ hydrocarbon which may be cyclopentane or isopentane, or combinations thereof.

Suitably, the C₂ to C₅ halogenated hydrocarbon is selected from 1,2-dichloroethene and isopropyl chloride, and combinations thereof.

Suitably the blowing agent comprises a halogenated hydroolefin, suitably selected from the group consisting of hydrofluoroolefins and hydrochloroolefins. suitably selected from the group consisting of 1-chloro-3,3,3-trifluoropropene, 1,3,3,3-tetrafluoro-1-propene, 2,3,3,3-tetrafluoro-1-propene, 1,1,1,4,4,4-hexofluoro-2-butene, and combinations thereof. The blowing agent may comprise 1-chloro-3,3,3-trifluoropropene, more suitably trans-1-chloro-3,3,3-trifluoropropene or cis-1-chloro-3,3,3-trifluoropropene or combinations thereof, preferably, trans-1-chloro-3,3,3-trifluoropropene.

The blowing agent of the composition of the invention may comprise C₁ to C₇ hydrocarbon from about 20 wt % to about 80 wt % of the total weight of blowing agent, suitably about 40 wt % to about 65 wt %, suitably about 45 wt % to about 60 wt % of the total weight of blowing agent.

The blowing agent of the composition of the invention may comprise C₂ to C₅ halogenated hydrocarbon from about 20 wt % to about 80 wt % of the total weight of blowing agent, suitably about 40 wt % to about 65 wt %, suitably about 45 wt % to about 60 wt % of the total weight of blowing agent.

The blowing agent of the composition of the invention may comprise a halogenated hydroolefin from about 20 wt % to about 80 wt % of the total weight of blowing agent, suitably about 35 wt % to about 60 wt %, suitably 40 wt % to 50 wt % of the total weight of blowing agent.

The acid catalyst may comprise an organic acid or an inorganic acid or a combination thereof. The acid catalyst may comprise sulfuric acid, or phosphoric acid, or benzene sulfonic acid, or xylene sulfonic acid, or paratoluene sulfonic acid, or naphthol sulfonic acid, or phenol sulfonic acid or a combination thereof. The composition may comprise the acid catalyst from about 1 to about 20 parts per 100 parts per weight of phenolic resin, suitably from about 5 to about 15 parts by weight.

The phenolic foam formed from the composition suitably has a pH of greater than 3 and less than 5 as measured by EN 13468:2001(e).

The phenolic foam formed from the composition suitably has a density below 100 kg/m³ as measured by ASTM D1622-14, suitably the phenolic foam has a density below 60 kg/m³, most suitably the phenolic foam has a density below about 35 kg/m³.

The phenolic foam formed from the composition suitably has a compressive strength from about 110 kPa to about 220 kPa as measured by BS EN 826:2013.

The phenolic foam formed from the composition suitably may have a friability from about 10% to about 50%, suitably from about 20% to about 40% as measured by ISO 6187.

The phenolic foam formed from the composition suitably has an aged thermal conductivity after ageing for 14 days at 110° C. of less than 0.022 W/m·K, for example less than 0.021 W/m·K, as measured by EN 13166:2012 (Method 2 Annex C).

The phenolic foam formed from the composition suitably has a closed cell content of greater than 90% when measured according to ASTM D2856, suitably a closed cell content of greater than 92%, suitably a closed cell content of greater than 95% when measured according to ASTM D2856.

### EXAMPLES

The present invention will be explained in detail with reference to Examples hereinafter, while the present invention will not be limited by these examples.

Phenolic foam products obtained in the Examples and Comparative Examples were measured for physical properties according to the following methods.

Thermal conductivity was measured according to EN 13166:2012 (Method 2 Annex C).

Phenolic foam samples of the Examples and Comparative Examples were dried at 70° C. for four days and thermal conductivity was measured according to EN 13166:2012.

Phenolic foam samples of the Examples and Comparative Examples were thermally aged at 110° C. for 14 days and conditioned according to EN 13166:2012 (Method 2 Annex C). This may be referred to the aged thermal conductivity.

pH of the phenolic foam was measured according to EN 13468:2001(e).

Density of the phenolic foam was measured according to ASTM D1622-14.

Compressive strength of the phenolic foam was measured according to BS EN826:2013.

Friability of the phenolic foam may be measured according to ISO 6187.

Closed cell content of the phenolic foam was measured according to ASTM D2856.

Water content was determined by Karl Fischer analysis and was performed using a Metrohm 870 KF Titrino.

Viscosity was determined using a Brookfield viscometer DV II+Pro instrument with a water batch attachment to measure viscosities at 25° C. or 40° C. depending on how viscous the resin is. A spindle is selected, and spindle rotation speed (RPM) required to achieve a torque between 35-55% (typically 20RPM)

### Resin “A” Preparation

The following resin was used in the foam examples below. Phenolic resole resin used is a liquid Phenol-Urea-Formaldehyde resin. Resin “A” has a Phenol:Urea:Formaldehyde molar ratio of 1:0.25:2.0. Resin “A” has a viscosity of 17000-24000 cPs at 25° C., weight average molecular weight 700 to 900, and pH 6 to 8.

Resin “A” resin contains from 4% to 6% free phenol, 0.1% to 0.5% free formaldehyde, and a water content of 4 to 9% (measured by Karl Fisher analysis).

The surfactants of the examples and comparative examples were mixed into resin “A” prior to the foam mixing procedure.

Foam Mixing Procedure

A phenolic foam product was prepared by foaming and curing a composition comprising:
(a) 100 parts of resin “A”
(b) a surfactant wherein the surfactant comprises 3.5 parts of an ethoxylated castor oil with from 10 to 50 ethylene oxide units and a surfactant of table 1, and
(c) a blowing agent of table 2.

To 100 parts by weight of Resin “A” phenolic resin which comprises the surfactant at 25° C. is added and mixed powdered urea in the amounts shown in table 3. The resin is allowed to stand for between 12 and 24 hours. Next, the amount of blowing agent as shown in table 3 at 1° C. is mixed into the resin. Once a uniform emulsion has formed, the resin mixture is cooled to between 5° C. and 10° C. Next para-toluene sulfonic acid/xylene sulfonic acid blend (65/35 w/w) at 92% concentration in the amount shown in table 3 is quickly mixed in at 8° C. Foaming commences immediately. Mixing of the acid into resin takes less than 10 seconds and the resin mix is quickly poured into a 30×30×2.5 cm picture frame mould preheated to 70-75° C.

TABLE 1
Polysiloxane surfactants

| Polysiloxane | Molecular weight of | Wt % polyethylene |
|---|---|---|
| surfactant | Polysiloxane surfactant | oxide (% EO) |
| A | 9457 | 37 |
| B | 15349 | 12 |
| C | 9671 | 32 |
| D | 14170 | 39 |
| E | 20479 | 30 |
| F | 14985 | 42 |
| G | 17281 | 51 |
| H | 16168 | 59 |
| I | 21950 | 51 |
| J | 26619 | 51 |

TABLE 2
Blowing agents

| Blowing | | Weight |
|---|---|---|
| agent | Blowing agent composition | ratio |
| A | Cyclopentane isopentane blend | 55.7:44.3 |
| | (85:15):HFO-1233zd(E) | |
| B | Cyclopentane isopentane blend | 50:50 |
| | (85:15):HFO-1336mmz(E) | |
| C | Cyclopentane isopentane blend | 52.4:47.6 |
| | (85:15):HFO-R1224zd(Z) | |
| D | Cyclopentane isopentane blend | 62.8:37.2 |
| | (85:15):t-DCE(E) | |
| E | Cyclopentane isopentane blend | 50:50 |
| | (85:15):HFO-1336mmz(Z) | |

TABLE 3
Foam compositions

| | | | Parts by weight per 100 weight PF resin | | | | | | |
|---|---|---|---|---|---|---|---|---|---|
| | Blowing | Polysiloxane | PF | | Ethoxylated | Polysiloxane | Hydro | | Acid |
| Examples | Agent | surfactant | Resin | Urea | castor oil | surfactant | carbon | HFO | catalyst |
| Comparative | A | C | 100 | 4.00 | 0 | 4.53 | 6.31 | 5.02 | 11.22 |
| Example 01 | | | | | | | | | |
| Comparative | A | — | 100 | 4.00 | 4.5 | 0 | 6.31 | 5.02 | 11.23 |
| Example 02 | | | | | | | | | |
| Comparative | A | G | 100 | 4.04 | 3.5 | 1 | 6.43 | 5.11 | 11.02 |
| Example 03 | | | | | | | | | |
| Comparative | A | I | 100 | 4.00 | 3.5 | 1 | 6.49 | 5.16 | 11.11 |
| Example 04 | | | | | | | | | |
| Comparative | A | J | 100 | 4.05 | 3.5 | 1 | 6.45 | 5.13 | 11.07 |
| Example 05 | | | | | | | | | |
| Comparative | A | H | 100 | 4.02 | 4.2 | 1 | 6.80 | 5.41 | 10.99 |
| Example 06 | | | | | | | | | |
| Example 01 | A | D | 100 | 3.70 | 3.5 | 1.00 | 7.00 | 5.50 | 15.00 |
| Example 02 | A | D | 100 | 3.70 | 3.5 | 1.00 | 7.00 | 5.50 | 14.00 |
| Example 03 | A | D | 100 | 3.70 | 3.5 | 1.00 | 7.00 | 5.50 | 13.00 |
| Example 04 | A | D | 100 | 3.70 | 3.5 | 1.00 | 6.00 | 4.80 | 13.00 |
| Example 05 | A | D | 100 | 3.70 | 3.5 | 1.00 | 6.90 | 5.60 | 13.00 |
| Example 06 | A | D | 100 | 3.85 | 3.5 | 1 | 6.44 | 5.13 | 10.97 |
| Example 07 | A | C | 100 | 4.00 | 3.5 | 1.01 | 6.31 | 5.02 | 11.23 |
| Example 08 | A | A | 100 | 3.86 | 3.5 | 1 | 5.85 | 4.66 | 9.54 |
| Example 09 | A | B | 100 | 3.96 | 3.4 | 1 | 5.92 | 4.71 | 10.64 |
| Example 10 | A | E | 100 | 3.84 | 3.4 | 1 | 6.05 | 4.82 | 10.66 |
| Example 11 | A | F | 100 | 4.00 | 4 | 1.01 | 6.76 | 5.38 | 11.15 |
| Example 12 | B | D | 100 | 3.70 | 3.5 | 1 | 6.81 | 6.81 | 11.25 |
| Example 13 | C | D | 100 | 3.70 | 3.5 | 1 | 6.40 | 5.81 | 11.10 |
| Example 14 | D | D | 100 | 3.70 | 3.5 | 1 | 6.94 | 4.11 | 11.05 |
| Example 15 | D | C | 100 | 4.00 | 3.5 | 1.01 | 6.69 | 3.97 | 11.22 |
| Example 16 | E | D | 100 | 3.7 | 3.5 | 1 | 6.93 | 6.93 | 11.72 |

The phenolic foams of Examples 1 to 16 and comparative examples 1 to 6 were formed from the compositions as set forth in Table 3. After drying for 4 days @ 70° C., thermal conductivity, compressive strength and density was measured. Thermal conductivity was further measured after aging for 14 days @ 110° C. The results are shown in table 4.

TABLE 4
Foam characteristics

| | | 14 days @ | | |
|---|---|---|---|---|
| | 4 day @ 70° C. | 110° C. | Compressive | Density |
| Examples | (mW/m · K) | (mW/m · K) | Strength (kPa) | (kg/m³) |
| Comparative | 24.93 | 31.53 | 65.63 | 27.29 |
| Example 01 | | | | |
| Comparative | 20.62 | 24.17 | 135.29 | 28.82 |
| Example 02 | | | | |
| Comparative | 18.35 | 22.59 | 101.73 | 28.30 |
| Example 03 | | | | |
| Comparative | 18.35 | 22.22 | 72.13 | 28.48 |
| Example 04 | | | | |
| Comparative | 19.62 | 24.79 | 171.45 | 30.69 |
| Example 05 | | | | |
| Comparative | 20.44 | 24.76 | 178.90 | 29.59 |
| Example 06 | | | | |
| Example 01 | 16.88 | 18.46 | 119.74 | 29.37 |
| Example 02 | 16.86 | 18.47 | 120.51 | 29.27 |
| Example 03 | 17.44 | 19.20 | 121.12 | 28.68 |
| Example 04 | 16.56 | 17.63 | 135.10 | 30.14 |
| Example 05 | 17.40 | 19.11 | 110.05 | 30.22 |
| Example 06 | 17.96 | 19.73 | N/A | 28.74 |
| Example 07 | 18.63 | N/A | 129.58 | 29.64 |
| Example 08 | 21.43 | N/A | N/A | 29.2 |
| Example 09 | 17.71 | 20.53 | N/A | 27.75 |
| Example 10 | 17.87 | 20.43 | N/A | 28.64 |
| Example 11 | 18.98 | N/A | 157.98 | 29.53 |
| Example 12 | 20.14 | N/A | 132.45 | 27.79 |
| Example 13 | 19.12 | 21.00 | 141.15 | 30.28 |
| Example 14 | 19.62 | N/A | 119.36 | 32.18 |
| Example 15 | 18.63 | N/A | 129.58 | 29.64 |
| Example 16 | 19.97 | 21.31 | 130.00 | 28.14 |

Comparative example 1 formed from a composition which did not contain ethoxylated castor oil exhibited poor thermal conductivity after drying for 4 days @ 70° C. and after aging for 14 days @ 110° C.

Comparative example 2 formed from a composition which did not contain a polysiloxane surfactant exhibited poor thermal conductivity after aging for 14 days @ 110° C.

The phenolic foams formed from a composition comprising a polysiloxane surfactant and an ethoxylated castor oil all exhibit acceptable thermal conductivity after drying for 4 days @ 70° C. but all exhibited poor thermal conductivity after aging for 14 days @ 110° C.

The surfactant has a significant effect on the structure of the cells of the foam. Comparative examples 1-6 produced foams in which the cell structure was irregular, there was a wide distribution of cell sizes, and some cells had coalesced to form large cells which all contributed to the foams exhibiting poor thermal conductivity after aging for 14 days @ 110° C.

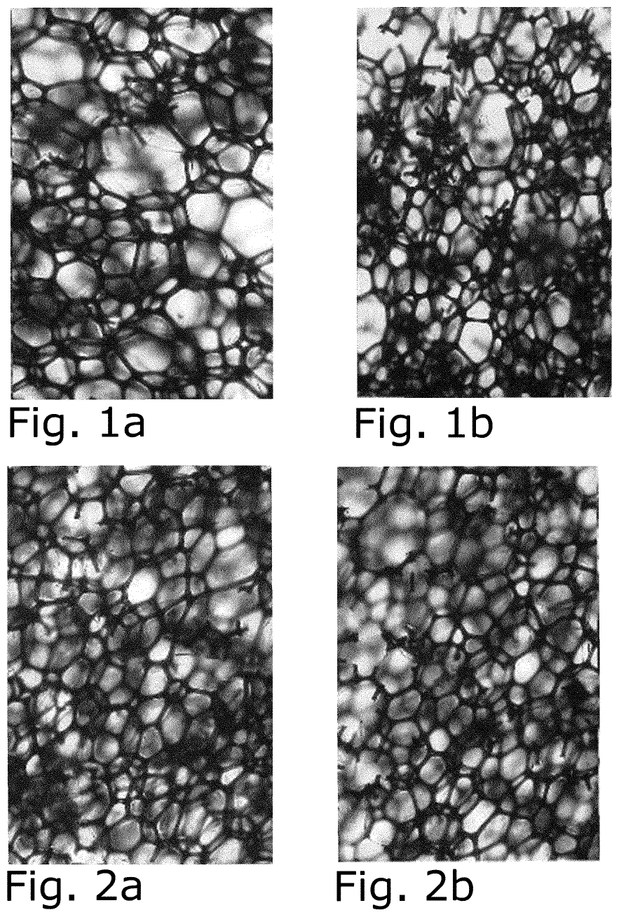

Images of comparative example 1 (FIG. 1) and comparative example 3 (FIG. 2) were taken using a Keyance digital microscope system VH-Z100R with a real zoom lens set to ×200 magnification. Both comparative examples 1 and 3 clearly show a wide distribution of cell sizes and presence of coalescence where cells have merged together to form large cells. The wide distribution of cell sizes and coalescence of cells leads to poor aged thermal conductivities. The presence of coalescence where cells have merged together to form larger cells leads to porous cells and poor aged thermal conductivities. The poor aged thermal conductivity exhibited by the foams of the comparative examples are as expected considering the poor cell structure.

The phenolic foams formed from a composition comprising a polysiloxane surfactant wherein the polysiloxane comprises a side chain which comprises polyethylene oxide wherein the total molecular weight of the polyethylene oxide of the side chain is less than 50% of the total molecular weight of the polysiloxane of examples 1 to 16 produced foams which had excellent cell structure with a regular and uniform distribution of closed cells. Minimal imperfections on the cell walls were observed and coalescence of cells was not observed. The cell structure of examples 1 to 16 provides the foams with excellent thermal conductivity after aging for 14 days @ 110° C.

The phenolic foams formed from the composition of examples 1 to 6 and 9, 10, 11, and 16 show less lambda drift and have both low thermal conductivity after drying for 4 days @ 70° C. and after aging for 14 days @ 100° C. The low aged thermal conductivity of these examples is as expected considering their excellent cell structure. Example 7, 8, and 11-16 also have excellent cell structure.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1-45. (canceled)

46. A phenolic foam formed from a composition comprising:
a phenolic resin,
a blowing agent,
an acid catalyst, and
a surfactant comprising:
(i) an ethoxylated castor oil, and
(ii) a polysiloxane comprising a side chain comprising polyethylene oxide wherein the total molecular weight of the polyethylene oxide of the side chain comprises less than 50% of the total molecular weight of the polysiloxane.

47. The phenolic foam as claimed in claim 46 wherein the polysiloxane has a molecular weight of from about 9,500 to about 25,000 g/mol.

48. The phenolic foam as claimed in claim 46 wherein the surfactant has a hydrophilic to lipophilic balance (HLB) of between about 9 to about 13.

49. The phenolic foam as claimed in claim 46, wherein the side chain comprises propylene oxide.

50. The phenolic foam as claimed in claim 46, wherein the polysiloxane comprises a block copolymer of a dimethylsiloxane and a polyoxyalkyene.

51. The phenolic foam as claimed in claim 46, wherein the polysiloxane has a HLB of from about 7 to about 11.

52. The phenolic foam as claimed in claim 46, wherein the ethoxylated castor oil has a HLB of from about 12 to about 14.

53. The phenolic foam as claimed in claim 46, wherein the composition comprises ethoxylated castor oil from about 0.5 to about 10 parts per 100 parts of the phenolic resin.

54. The phenolic foam as claimed in claim 46, wherein the surfactant comprises 10% to 30% polysiloxane by weight based on the total weight of the surfactant.

55. The phenolic foam as claimed in claim 46, wherein the mixture of phenolic resin and surfactant of the composition has a viscosity of from about 2,600 cPs to about 4,000 cPs at 40° C.

56. The phenolic foam as claimed in claim 46, wherein the phenolic resin has a free formaldehyde content of from about 0.1% to about 0.5% when measured by titration according to ISO 11402:2004.

57. The phenolic foam as claimed in claim 46, wherein the blowing agent comprises a C₁-C₇ hydrocarbon, a C₂ to C₅ halogenated hydrocarbon, or a halogenated hydroolefin, or combination thereof.

58. The phenolic foam as claimed in claim 46, wherein the blowing agent comprises a halogenated hydroolefin selected from the group consisting of hydrofluoroolefins and hydrochlorofluoroolefins.

59. The phenolic foam as claimed in claim 46, wherein the blowing agent of the composition comprises from about 20 wt % to about 80 wt % C₁-C₇ hydrocarbon of total weight of blowing agent.

60. The phenolic foam as claimed in claim 46, wherein the blowing agent of the composition comprises from about 20 wt % to about 80 wt % halogenated hydroolefin of total weight of blowing agent.

61. The phenolic foam as claimed in claim 46, wherein the blowing agent comprises from 30 wt % to 50 wt % 1-chloro-3,3,3-trifluoropropene and from 50 wt % to 70 wt % C₁-C₇ hydrocarbon based on the total weight of the blowing agent.

62. The phenolic foam as claimed in claim 46, wherein the phenolic foam has a density of from about 10 kg/m³ to about 100 kg/m³ as measured according to ASTM D1622-14.

63. The phenolic foam as claimed in claim 46, wherein the phenolic foam has a compressive strength of from about 110 kPa to about 220 kPa, as measured by BS EN 826:2013.

64. The phenolic foam as claimed in claim 46, wherein the phenolic foam has an aged thermal conductivity of 0.022 W/m·K or less when measured after aging for 14 days at 110° C. as measured according to 13166:2012.

65. A phenolic foam composition comprising:
a phenolic resin,
a blowing agent,
an acid catalyst, and
a surfactant comprising:
(i). an ethoxylated castor oil, and
(ii). a polysiloxane comprising a side chain comprising polyethylene oxide wherein the total molecular weight of the polyethylene oxide of the side chain comprises less than 50% of the total molecular weight of the polysiloxane.

66. A thermal insulation comprising the phenolic foam of claim 46.

67. A method of manufacturing a phenolic foam comprising:
a. mixing a phenolic resin, a blowing agent, and a surfactant wherein the surfactant comprises
i. an ethoxylated castor oil, and
ii. a polysiloxane comprising a side chain comprising polyethylene oxide wherein the total molecular weight of the polyethylene oxide of the side chain comprises less than 50% of the total molecular weight of the polysiloxane, and
b. adding an acid catalyst to catalyse a foaming reaction and produce a foam.
